(19) United States
(12) Patent Application Publication
(10) Pub. No.: US 2012/0191342 A1
(43) Pub. Date: Jul. 26, 2012

(54) Information Displaying System for Use with a Vehicle Head-Up Display

(75) Inventors: Weon Eui Kang, Gyeonggi-Do (KR); Byeong Sup Moon, Gyeonggi-Do (KR); Bum Jin Park, Gyeonggi-Do (KR); Hyuk Kyu Lim, Gyeonggi-Do (KR); Seok Jae Choi, Incheon-Si (KR)

(73) Assignees: V & I CO., LTD., A KOREAN, Gyeonggi-Do (KR); KOREA INSTITUTE OF CONSTRUCTION TECHNOLOGY, Gyeonggi-Do (KR)

(21) Appl. No.: 13/093,747

(22) Filed: Apr. 25, 2011

Related U.S. Application Data
(60) Provisional application No. 61/436,512, filed on Jan. 26, 2011.

(51) Int. Cl. G01C 21/36; G09G 5/10

(52) U.S. Cl. 701/423; 701/436; 345/690

(57) ABSTRACT

An information-displaying system is provided for use with a vehicle head-up display including a liquid crystal panel for displaying drive information image, a backlight unit for irradiating light toward the liquid crystal panel, an optical system for enlarging or reducing the drive information image displayed on the liquid crystal panel, and a reflection mirror for reflecting the drive information image projected by the optical system toward a windshield of a motor vehicle. The information-displaying system includes a navigation information providing unit for providing navigation information on a current vehicle position, a road map and an optimum route to destination, a traffic information providing unit for providing traffic information on a real time basis, and a control unit for controlling the liquid crystal panel to display the navigation information and the traffic information provided by the navigation information providing unit and the traffic information providing unit.

### CROSS-REFERENCE TO RELATED APPLICATION

This application claims the benefit of U.S. Provisional Patent Application Ser. No. 61/436,512, filed on Jan. 26, 2011, which application is incorporated herein by reference in its entirety.

### FIELD OF THE INVENTION

The present invention relates to an information-displaying system for use with a vehicle head-up display, capable of displaying not only basic vehicle information but also navigation information and real-time traffic information to thereby enhance a driver's convenience to the highest degree and assure safe driving through the elimination of a need to turn the driver's eyes.

### BACKGROUND OF THE INVENTION

In recent years, various kinds of devices have been developed in an effort to enhance the driver's convenience and the safe driving. One example of such devices is a head-up display (HUD) for motor vehicles. The head-up display is designed to display a variety of drive information, e.g., a vehicle speed, a revolution per minute and a residual fuel amount, on the windshield of a vehicle.

An LCD type head-up display is primarily used as the head-up display for motor vehicles. Referring to FIG. 1, the LCD type head-up display includes a liquid crystal panel 10 and a backlight unit 12 arranged at the rear side of the liquid crystal panel 10. The liquid crystal panel 10 is installed inside of an instrument panel 10a in front of a driver seat so that it can display a drive information image. The backlight unit 12 serves as a light source for irradiating light on the rear surface of the liquid crystal panel 10.

The LCD type head-up display further includes an optical system 14 arranged at the front side of the liquid crystal panel 10 and a reflection mirror 16 installed at the front side of the optical system 14 at a specified angle. The optical system 14 serves to enlarge or reduce the drive information image appearing on the liquid crystal panel 10 and to adjust the focal distance of the drive information image. The reflection mirror 16 reflects the drive information image projected by the optical system 14 toward the windshield 18 of a motor vehicle. This makes it possible to display the drive information image on the windshield 18.

Since the head-up display is designed to display a variety of drive information on the windshield 18, it is possible for a driver to readily recognize the drive information of a vehicle without having to look at the instrument panel 10a.

It is desirable for the head-up display to display all the information required in driving a motor vehicle, including the basic vehicle information such as a vehicle speed, a revolution per minute and a residual fuel amount. In particular, there is a need to display navigation information and real-time traffic information.

### SUMMARY OF THE INVENTION

It is, therefore, an object of the present invention to provide an information-displaying system for use with a vehicle head-up display, capable of displaying not only basic vehicle information but also navigation information and real-time traffic information on a windshield to thereby enhance the driver's convenience to the highest degree.

Another object of the present invention is to provide an information-displaying system for use with a vehicle head-up display, capable of displaying navigation information and real-time traffic information on a windshield to thereby assure the safe driving through the elimination of a need to turn the driver's eyes.

In accordance with the present invention, there is provided an information-displaying system for use with a vehicle head-up display including a liquid crystal panel for displaying drive information image, a backlight unit for irradiating light toward the liquid crystal panel, an optical system for enlarging or reducing the drive information image displayed on the liquid crystal panel and for adjusting a focal distance of the drive information image, and a reflection mirror for reflecting the drive information image projected by the optical system toward a windshield of a motor vehicle, the information-displaying system comprising: a navigation information providing unit for providing navigation information on a current vehicle position, a road map and an optimum route to destination; a traffic information providing unit for providing traffic information on a real time basis; and a control unit for controlling the liquid crystal panel to display the navigation information and the traffic information provided by the navigation information providing unit and the traffic information providing unit respectively.

In the information-displaying system, the navigation information providing unit may include a navigation system including a global positioning system and a map, the navigation system being designed to grasp the current vehicle position and indicate the current vehicle position on the map.

In the information-displaying system, the navigation information providing unit may include an existing navigation system previously installed in the motor vehicle and connected to the control unit through a wire or wireless interface device.

In the information-displaying system, the traffic information providing unit may include: a remote traffic information database unit for collecting, analyzing and storing road information and traffic information on a current traffic jam situation, a current traffic regulation situation and a current traffic accident situation to provide the road information and the traffic information on a real time basis; and a wireless interface unit for sending the traffic information provided by the traffic information database unit to the control unit through wireless communication.

In the information-displaying system, the wireless interface unit may include a wireless broadband modem for receiving the traffic information transmitted from the traffic information database unit through a wireless broadband network.

With the present information-displaying system summarized above, it is possible to display not only the basic vehicle information but also the navigation information and the real-time traffic information on a windshield, thereby enhancing the driver's convenience to the highest degree. By additionally displaying the navigation information and the real-time traffic information on the windshield, it is possible to assure the safe driving through the elimination of a need to turn the driver's eyes.

### BRIEF DESCRIPTION OF THE DRAWINGS

The above and other objects and features of the present invention will become apparent from the following description of preferred embodiments, given in conjunction with the accompanying drawings.

FIG. 1 is a view schematically showing a conventional head-up display for motor vehicles.

FIG. 2 is a view schematically showing an information-displaying system for use with a vehicle head-up display in accordance with one embodiment of the present invention.

### DETAILED DESCRIPTION OF THE PREFERRED EMBODIMENTS

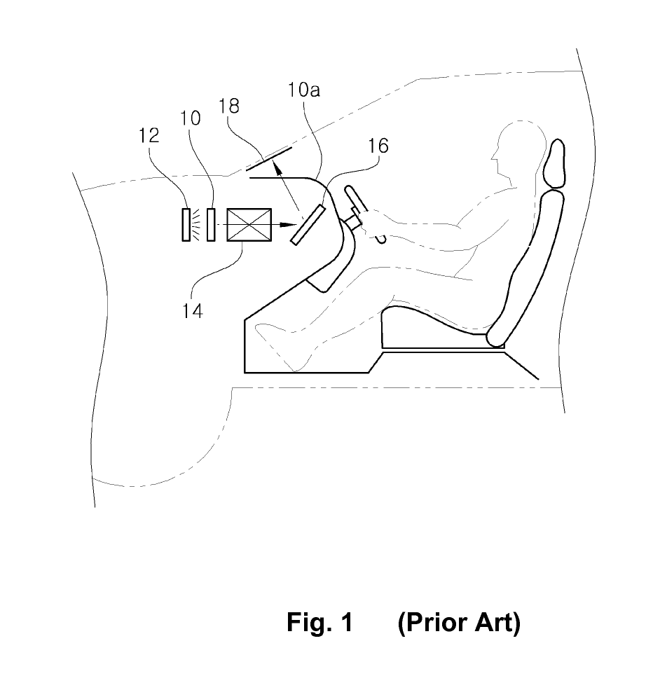

One preferred embodiment of an information-displaying system for use with a vehicle head-up display will now be described in detail with reference to the accompanying drawings. The same components as those of the conventional head-up display shown in FIG. 1 will be designated by the same reference numerals.

Brief description on a general vehicle head-up display will precede the description of the information-displaying system for use with a vehicle head-up display according to one embodiment of the present invention.

The vehicle head-up display includes a liquid crystal panel 10 and a backlight unit 12 arranged at the rear side of the liquid crystal panel 10. The liquid crystal panel 10 is installed inside of an instrument panel 10a in front of a driver seat so that it can display a drive information image. The backlight unit 12 serves as a light source for irradiating light on the rear surface of the liquid crystal panel 10.

The vehicle head-up display further includes an optical system 14 arranged at the front side of the liquid crystal panel 10 and a reflection mirror 16 installed at the front side of the optical system 14 at a specified angle. The optical system 14 serves to enlarge or reduce the drive information image appearing on the liquid crystal panel 10 and to adjust the focal distance of the drive information image. The reflection mirror 16 reflects the drive information image projected by the optical system 14 toward the windshield 18 of a motor vehicle. This makes it possible to display the drive information image on the windshield 18.

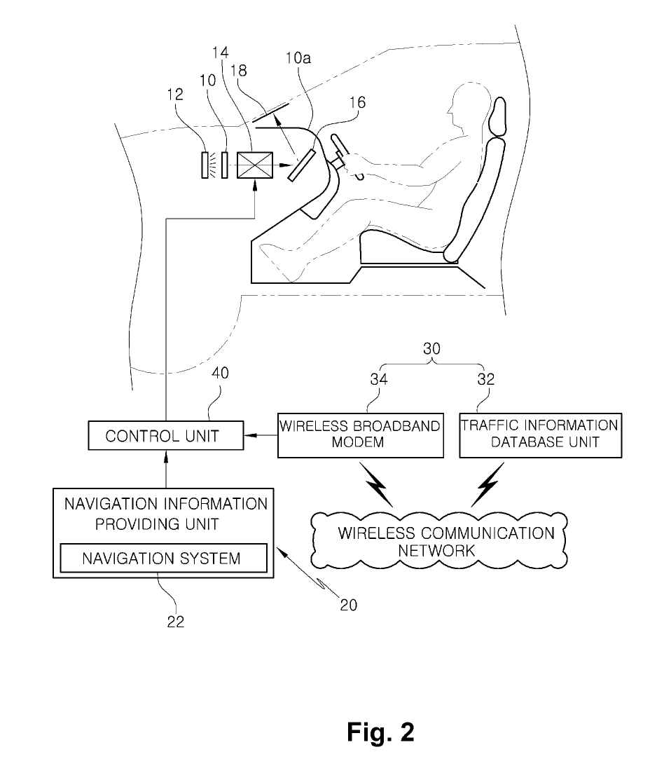

Next, the information-displaying system for use with a vehicle head-up display according to one embodiment of the present invention will be described in detail with reference to FIG. 2.

The present information-displaying system includes a navigation information providing unit 20 for providing navigation information such as current vehicle position, a road map and optimum route information. The navigation information providing unit 20 includes a conventional navigation system 22 and remains connected to a control unit 40 to be described later. The navigation system 22 includes a GPS (Global Positioning System) and a map, and serves to grasp the current vehicle position and indicates the current vehicle position on the map appearing on the liquid crystal panel 10.

By providing the navigation information such as current vehicle position, road map information and optimum route information to the vehicle head-up display, the navigation information providing unit 20 enables the head-up display to display the navigation information on the windshield 18 of a motor vehicle. This eliminates the need for a driver to look at the navigation system during the driving of the motor vehicle. Consequently, it is not necessary for the driver to turn his or her eyes to see the navigation system, thereby assuring the safe driving.

The navigation system 22 of the navigation information providing unit 20 is built in the vehicle head-up display. If necessary, an existing navigation system previously installed in a motor vehicle may be used. In case of using the existing navigation system, there is a need to connect the existing navigation system to the vehicle head-up display through a wire or wireless interface device (not shown). The navigation system 22 thus connected provides navigation information to the vehicle head-up display.

Referring again to FIG. 2, the present information-displaying system further includes a traffic information providing unit 30 for providing traffic information on a real time basis. The traffic information providing unit 30 includes a remote traffic information database unit 32 storing real-time traffic information and a wireless interface unit for interconnecting the traffic information database unit 32 and the vehicle head-up display through a wireless communication.

The traffic information database unit 32 is installed in a traffic control surveillance center that manages general traffic conditions. The traffic information database unit 32 collects, analyzes and stores various kinds of road information and traffic information inputted from closed-circuit TVs, traffic correspondents and other traffic information providers. The traffic information database unit provides a driver with traffic information such as a current traffic jam situation, a current traffic regulation situation and a current traffic accident situation on a real time basis.

The wireless interface unit includes a wireless broadband modem 34 capable of receiving the real-time traffic information transmitted from the traffic information database unit 32 through a wireless communication network, e.g., a wireless broadband network. The wireless broadband network is a wireless internet network featuring high speed of data transmission. The wireless broadband network is suitable for use in transmitting a large volume of data rapidly and is currently adopted by some mobile communication companies. The wireless broadband modem 34 includes a wireless broadband chip arranged therein and functions to convert the data signals transmitted through the wireless broadband network to signals suitable for use in the information-displaying system.

By receiving the real-time traffic information from the traffic information database unit 32 and sending it to the vehicle head-up display, the wireless interface unit enables the head-up display to display the real-time traffic information on the windshield 18. This makes it possible for a driver to rapidly recognize the traffic information such as a current traffic jam situation, a current traffic regulation situation and a current traffic accident situation and to appropriately cope with the current traffic situation while driving a motor vehicle.

While the wireless broadband modem 34 is employed as one example of the wireless interface unit in the present embodiment, it may be possible to use a HSDPA (High-Speed Downlink Packet Access) modem or other modems. The HSDPA modem is designed to send and receive HSDPA signals and can receive the real-time traffic information from the traffic information database unit 32 through a HSDPA.

Alternatively, interactive multimedia based on the wireless broadband modem 34 or the HSDPA modem, IPTVs (Internet Protocol Televisions) or UCC (User-Created Contents) may be used as the wireless interface unit to receive the real-time traffic information. Since the interactive multimedia, the IPTVs and the UCC are well-known in the art, no description will be offered in that regard.

In the present embodiment, the wireless broadband modem of the wireless interface unit is built in the vehicle head-up display. If necessary, the wireless broadband modem 34 may be attached to an existing navigation system previously installed in a motor vehicle. In case where the wireless broadband modem 34 is attached to an existing navigation system, it is necessary to connect the wireless broadband modem 34 to the head-up display through an additional wire or wireless interface device (not shown). The wireless broadband modem 34 thus connected can provide the real-time traffic information to the head-up display.

Referring again to FIG. 2, the present information-displaying system further includes a control unit 40 provided with a microprocessor and a drive circuit. The control unit 40 controls the liquid crystal panel 10 by processing the data inputted from the navigation information providing unit 20 and the traffic information providing unit 30. In particular, the control unit 40 is designed to generate image signals using the information on the current vehicle position, the road map and the optimum route to destination. The control unit 40 controls the liquid crystal panel 10 with the image signals thus generated, so that the liquid crystal panel 10 can display the current vehicle position, the road map and the optimum route to destination. Thus, an image corresponding to the one appearing in the liquid crystal panel 10 can be displayed on the windshield 18. Moreover, the control unit 40 is designed to generate image signals using the information on the current traffic jam situation, the current traffic regulation situation and the current traffic accident situation. The control unit 40 controls the liquid crystal panel 10 with the image signals thus generated, so that the liquid crystal panel 10 can display the current traffic jam situation, the current traffic regulation situation and the current traffic accident situation. This makes it possible for a driver to recognize the traffic information through the windshield 18 on a real time basis.

With the present information-displaying system configured as above, it is possible to display not only the basic vehicle information but also the navigation information and the real-time traffic information on a windshield, thereby enhancing the driver's convenience to the highest degree. By additionally displaying the navigation information and the real-time traffic information on the windshield, it is possible to assure the safe driving through the elimination of a need to turn the driver's eyes.

While one preferred embodiment of the invention has been described hereinabove, the present invention is not limited thereto. It is to be understood that various changes and modifications may be made without departing from the scope of the invention defined in the claims.

What is claimed is:

1. An information-displaying system for use with a vehicle head-up display including a liquid crystal panel for displaying drive information image, a backlight unit for irradiating light toward the liquid crystal panel, an optical system for enlarging or reducing the drive information image displayed on the liquid crystal panel and for adjusting a focal distance of the drive information image, and a reflection mirror for reflecting the drive information image projected by the optical system toward a windshield of a motor vehicle, the information-displaying system comprising:
a navigation information providing unit for providing navigation information on a current vehicle position, a road map and an optimum route to destination;
a traffic information providing unit for providing traffic information on a real time basis; and
a control unit for controlling the liquid crystal panel to display the navigation information and the traffic information provided by the navigation information providing unit and the traffic information providing unit.

2. The information-displaying system as recited in claim 1, wherein the navigation information providing unit comprises a navigation system including a global positioning system and a map, the navigation system being designed to grasp the current vehicle position and indicate the current vehicle position on the map.

3. The information-displaying system as recited in claim 1, wherein the navigation information providing unit comprises an existing navigation system previously installed in the motor vehicle and connected to the control unit through a wire or wireless interface device.

4. The information-displaying system as recited in claim 1, wherein the traffic information providing unit includes:
a remote traffic information database unit for collecting, analyzing and storing road information and traffic information on a current traffic jam situation, a current traffic regulation situation and a current traffic accident situation to provide the road information and the traffic information on a real time basis; and
a wireless interface unit for sending the traffic information provided by the traffic information database unit to the control unit through wireless communication.

5. The information-displaying system as recited in claim 4, wherein the wireless interface unit includes a wireless broadband modem for receiving the traffic information transmitted from the traffic information database unit through a wireless broadband network.
